(19) United States
(12) Patent Application Publication
(10) Pub. No.: US 2013/0076575 A1
(43) Pub. Date: Mar. 28, 2013

(54) PORTABLE ELECTRONIC APPARATUS WITH ANTENNA STRUCTURE

(71) Applicants: Ching-Chia Mai, Hsinchu (TW); Chih-Ching Hsu, Hsinchu (TW); Cheng-Han Lee, Hsinchu (TW); Yuan-Chin Hsu, Hsinchu (TW)

(72) Inventors: Ching-Chia Mai, Hsinchu (TW); Chih-Ching Hsu, Hsinchu (TW); Cheng-Han Lee, Hsinchu (TW); Yuan-Chin Hsu, Hsinchu (TW)

(21) Appl. No.: 13/334,067

(22) Filed: Dec. 22, 2011

(30) Foreign Application Priority Data
Sep. 28, 2011 (TW) 100135020

(51) Int. Cl. H01Q 1/24

(52) U.S. Cl. 343/702

(57) ABSTRACT

A portable electronic apparatus with antenna structure is disclosed. The portable electronic apparatus includes an apparatus casing, an antenna structure, and an electronic component. The apparatus casing has an accommodating space and an appearance casing. The antenna structure is disposed adjacent to the appearance casing. The electronic component is disposed in the accommodating space and leaks electromagnetic wave during operation. Thereby, even though the electronic component leaks electromagnetic wave toward the antenna structure, the invention can reduce the influence on the antenna structure by the leaked electromagnetic wave by disposing the antenna structure as away from the electronic component as possible. Therefore, the antenna structure still can work normally during the operation of the electronic component, which solves the problem that an antenna structure of a conventional portable electronic apparatus is easily interrupted in the range of the leaked electromagnetic wave in the prior art.

### BACKGROUND OF THE INVENTION

1. Field of the Invention

The invention relates to a portable electronic apparatus, and especially relates to a portable electronic apparatus with antenna structure.

2. Description of the Prior Art

The volume for cell phones is designed to be smaller and smaller. Old antenna structures with protrusion design appear to be very incongruous, so antennas for current cell phones are usually plate antennas and disposed inside the cell phones. Antennas transmit or receive messages by use of electromagnetic wave traveling through space. Any electromagnetic wave may possibly influence the normal operation of the antennas. The cell phone has many electronic components inside. It is unavoidable for each of the electronic components to radiate electromagnetic wave additionally during operation. Under the constraint of the small volume of the current cell phones, the radiated electromagnetic wave influences the operation of the antenna less or more. Ina design for some cell phones, the electronic components close to an antenna are shielded so as to reduce the influence of electromagnetic wave leaked from the electronic components on the operation of the antenna. Accordingly, the design is usually to constrain the antenna at a single side or a corner of the casing of the cell phone. It limits the layout space for the antenna and the ability of transmitting and receiving of the antenna. In addition, it is not possible for all electronic components to be shielded with metal casings or other wave-absorbing and magnetic materials. For example, a touch panel needs to be touched by a user during operation, so it is difficult to shield the touch panel completely. The leakage of electromagnetic wave is therefore unavoidable, so that the antenna is easily interrupted in the range of the leaked electromagnetic wave. Furthermore, the size of the touch panel is designed to be larger and larger. Only less space remains inside the cell phone for the antenna disposition, which makes the above problem worse.

### SUMMARY OF THE INVENTION

An objective of the invention is to provide a portable electronic apparatus with antenna structure. The antenna structure of the portable electronic apparatus is disposed as away from electronic components inside the portable electronic apparatus as possible, so as to reduce the influence of leaked electromagnetic wave effectively on the antenna structure to improve the efficiency of the antenna structure.

The portable electronic apparatus with antenna structure of the invention includes an apparatus casing, an antenna structure, and an electronic component. The apparatus casing has an accommodating space and an appearance casing. The antenna structure is disposed adjacent to the appearance casing. The electronic component is disposed in the accommodating space and leaks electromagnetic wave electromagnetic wave substantially toward the antenna structure. Thereby, even if the electronic component leaks electromagnetic wave electromagnetic wave toward the antenna structure, the influence of the leaked electromagnetic wave on the antenna structure can be reduced effectively because the antenna structure is disposed as away from the electronic component as possible. Therefore, the antenna structure still can work normally during the operation of the electronic component, which solves the problem that an antenna structure of a conventional portable electronic apparatus is easily interrupted in the range of the leaked electromagnetic wave in the prior art.

Another objective of the invention is to provide a portable electronic apparatus with antenna structure including an apparatus casing and an antenna structure. The apparatus casing includes an appearance casing. The antenna structure is disposed on an outer surface of the appearance casing. Similarly, the antenna structure of the portable electronic apparatus is disposed outside the apparatus, which also can achieve the purpose of disposing away from electronic components inside the apparatus casing. So the portable electronic apparatus also can reduce the influence effectively on the antenna structure by the leaked electromagnetic wave so as to improve the efficiency of the antenna structure.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a sectional view of a portable electronic apparatus 1 of a preferred embodiment according to the present invention.

FIG. 2 is a schematic diagram illustrating the disposition of the antenna structure in FIG. 1.

FIG. 3 is a schematic diagram illustrating the disposition of the antenna structure in FIG. 1 according to another embodiment.

FIG. 4 is a schematic diagram illustrating the disposition of an antenna structure according to another embodiment.

FIG. 5 is a sectional view of a portable electronic apparatus with the antenna structure formed on an outer surface of its decoration casing according to another embodiment.

FIG. 6 is a sectional view of a portable electronic apparatus with the antenna structure formed on an outer surface of its battery back cover according to another embodiment.

### DETAILED DESCRIPTION

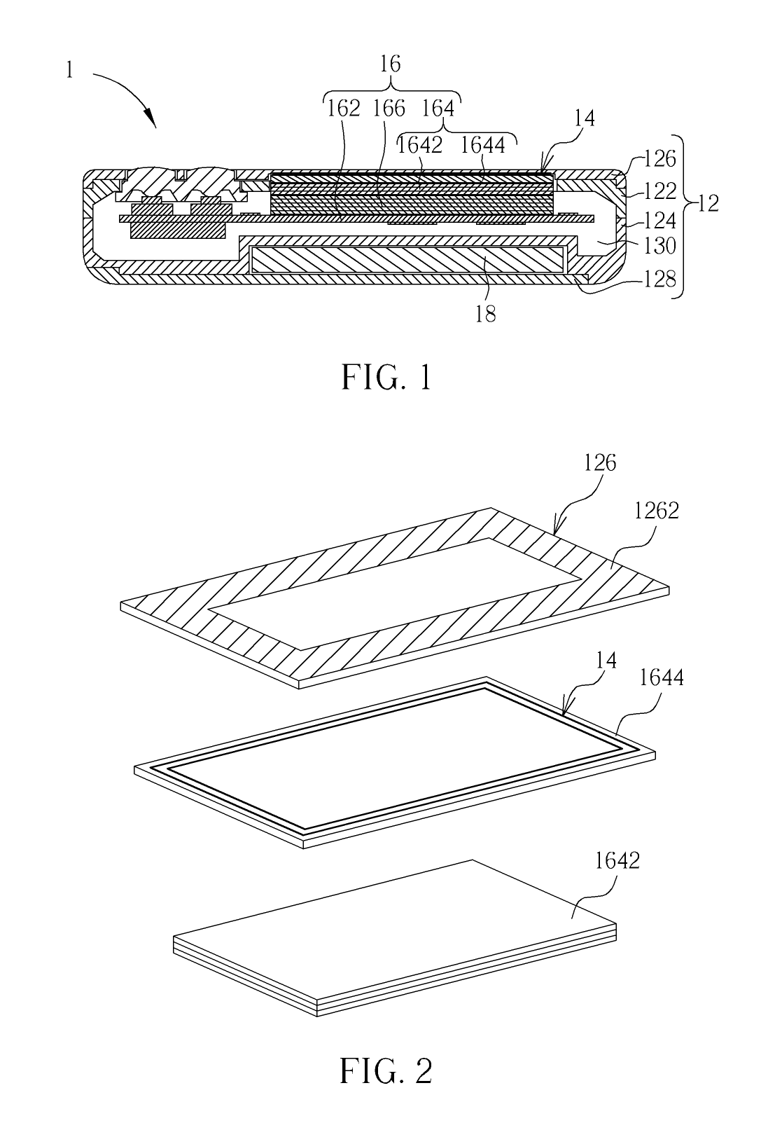

Please refer to FIG. 1, which is a sectional view of a portable electronic apparatus 1 of a preferred embodiment according to the present invention. In the embodiment, the portable electronic apparatus 1 is a smart phone, but the invention is not limited to it. For example, personal digital assistant, tablet computer and so on are also applicable. The portable electronic apparatus 1 includes an apparatus casing 12, an antenna structure 14 (shown by bold lines in FIG. 1), a main board module 16, a battery 18. The apparatus casing 12 includes an upper cover 122, a lower cover 124, a decoration casing 126, and a battery back cover 128. The upper cover 122 and the lower cover 124 are connected to form an accommodating space 130. The main board module 16 is disposed in the accommodating space 130. The decoration casing 126 is disposed on the upper cover 122 for decorating the portable electronic apparatus 1. The battery 18 is disposed on the lower cover 124 and electrically connected to the main board module 16. The battery back cover 128 and the lower cover 124 are connected for fixing and protecting the battery 18. The main board module 16 includes a main board 162 and an electronic component 164 electrically connected to the main board 162. In the embodiment, the electronic component 164 includes a touch panel 1642 and an insulation protection cover 1644. The insulation protection cover 1644 is a glass cover above the touch panel 1642 for the protection of the touch panel 1642. The antenna structure 14 is disposed adjacent to the decoration casing 126. In the embodiment, the antenna structure 14 is between the decoration casing 126 and the insulation protection cover 1644. In addition, a touch panel generally is integrated with a display panel, so in the embodiment, the main board module 16 also include a liquid crystal display (LCD) panel 166, on which the touch panel 1642 is disposed.

Please also refer to FIG. 2. FIG. 2 is a schematic diagram illustrating the disposition of the antenna structure 14 in FIG. 1. For clear description, the decoration casing 126, the insulation protection cover 1644, and the touch panel 1642 are shown in plates, also in the following figures; it is not repeated hereafter. The area of the insulation protection cover 1644 is larger than that of the touch panel 1642. The antenna structure 14 is disposed on a border portion of the insulation protection cover 1644 so as not to cover the touch panel 1642 excessively to influence the touch function. The decoration casing 126 includes a covering border portion 1262 (shown by dashed lines) for covering the antenna structure 14, the periphery structure of the electronic component 164, and other structures inside the apparatus casing 12 for embellishing the appearance of the portable electronic apparatus 1. The antenna structure 14 can be formed on insulation protection cover 1644 directly by printing or by a specific technical art. In the latter, laser direct structuring (LDS) is applicable to form a pattern for the antenna on the insulation protection cover 1644 and to produce a metal film with a required thickness and required electrical characteristics by electroplating or chemical plating. However, the invention is not limited the above. In principle, any technique capable of forming the antenna structure 14 on the insulation protection cover 1644 is applicable to the invention. It is added that in the embodiment, the insulation protection cover 1644 is made of glass, but the invention is not limited thereto. In practice, the insulation protection cover 1644 can be made of high molecular polymer. In this case, the antenna structure 14 can be formed together with the insulation protection cover 1644 by co-injection molding or by insertion molding. The both can obtain the structure of the antenna structure embedded into the insulation protection cover 1644 to obtain the smooth appearance of the insulation protection cover 1644.

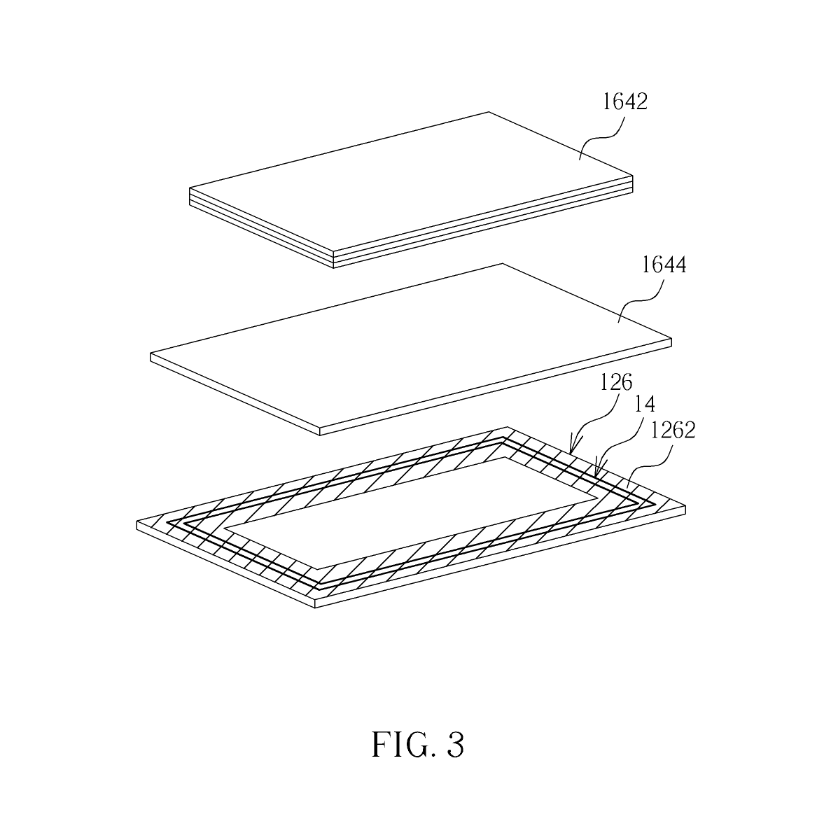

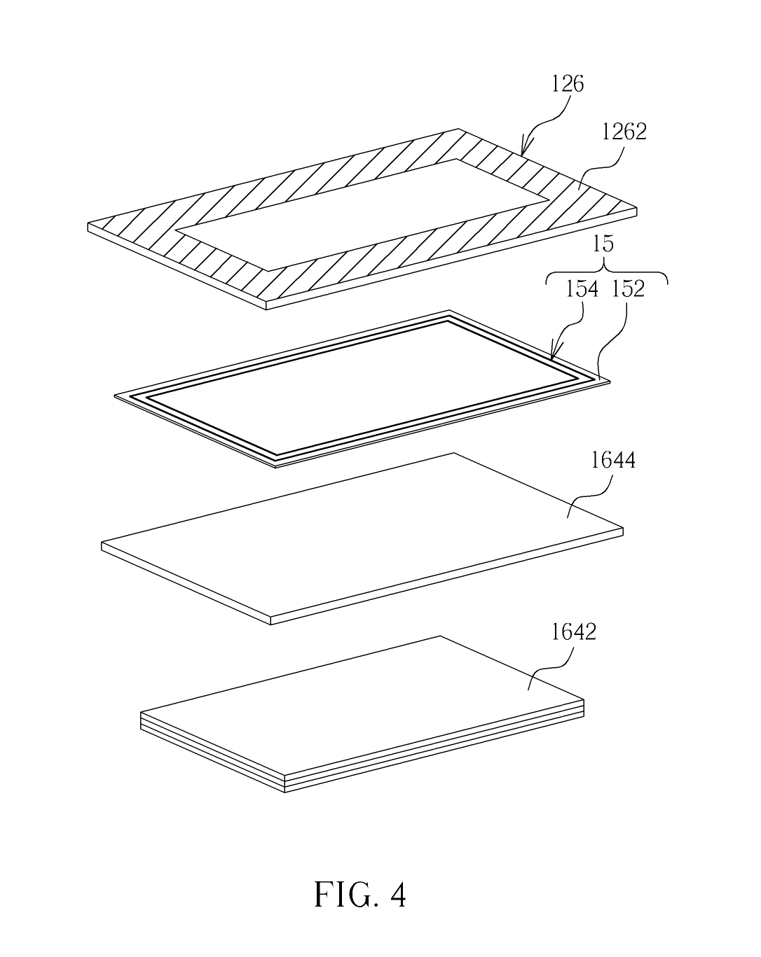

As shown in FIG. 1, the insulation protection cover 1644 is disposed adjacent to the decoration casing 126 in the accommodating space 130. In practice, the antenna structure 14 is not limited to be formed directly on the insulation protection cover 1644. Please refer to FIG. 1 and FIG. 3. FIG. 3 is a schematic diagram illustrating the disposition of the antenna structure 14 in FIG. 1 according to another embodiment; therein, the viewpoint of FIG. 3 is opposite to that of FIG. 2 for showing the disposition of the antenna structure 14. In the embodiment, the antenna structure 14 in FIG. 3 is formed on an inner surface of the decoration casing 126 and at the covering border portion 1262 such that the antenna structure 14 can be covered by the covering border portion 1262 after the decoration casing 126 is assembled. For the description of the formation of the antenna structure 14, please refer to related description of the formation of the antenna structure 14 in FIG. 2; it is not repeated herein. It is added that the above embodiments are based on the fact that the antenna structure 14 is formed directly on the decoration casing 126 or the insulation protection cover 1644, but the invention is not limited thereto. Please refer FIG. 4, which is a schematic diagram illustrating the disposition of an antenna structure 15 according to another embodiment. In the embodiment, the antenna structure 15 is a independent member including a substrate 152 and a radiating element 154 formed on the substrate 152. The substrate 152 can be made of transparent material or be formed with a hollowed centric portion. The antenna structure 15 can be attached onto the decoration casing 126 or the insulation protection cover 1644, or just be disposed between the decoration casing 126 and the insulation protection cover 1644.

As discussed in the above embodiments, the decoration casing 126 is an appearance casing of the apparatus casing 12. The antenna structures 14 and 15 are disposed inside the decoration casing 126, so the portable electronic apparatus 1 can have the smooth appearance. Though the touch panel 1642 leaks electromagnetic wave toward the antenna structures 14 and 15 during operation, the influence of the leaked electromagnetic wave by the touch panel 1642 and the LCD panel 166 during operation on the antenna structures 14 and 15 can be reduced effectively because the antenna structures 14 and 15 are disposed relatively far away from the touch panel 1642, separated from the touch panel 1642 with the insulation protection cover 1644, and disposed around the touch panel 1642.

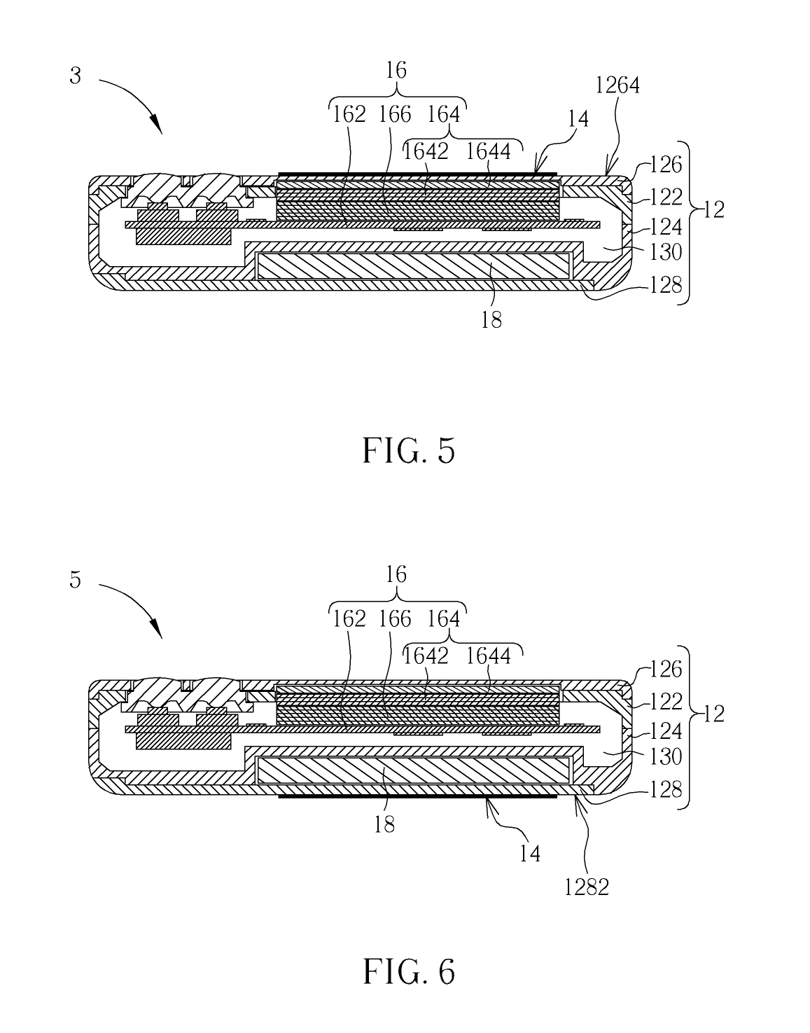

In principle, the farther away from the electronic component 164 the antenna structures 14 and 15 are disposed, the better the performance of the antenna structures 14 and 15 are. So in practice, the disposition of the antenna structure of the invention is not limited to those in the above embodiments. Please refer to FIG. 5, which is a sectional view of a portable electronic apparatus 3 according to another embodiment. In the embodiment, the antenna structure 14 (shown by bold lines in FIG. 5) is disposed directly on outer surface 1264 of the decoration casing 126. Similarly, the portable electronic apparatus 3 also can reduce the influence of the leaked electromagnetic wave by the touch panel 1642 and the LCD panel 166 during operation effectively on the antenna structure 14. In practice, the whole decoration casing 126 can be coated with a protection film to protect the antenna structure 14 and to obtain smooth touch feeling on the decoration casing 126. The above antenna structure 15 is also applicable to the configuration in FIG. 5; it is not repeated herein.

In the above embodiments, the decoration casing 126 and the battery back cover 128 are most outer casings of the apparatus casing 12, so the antenna structures 14 and 15 can be disposed on the battery back cover 128. Please refer to FIG. 6, which is a sectional view of a portable electronic apparatus 5 according to another embodiment. In the embodiment, the antenna structure 14 (shown by bold lines in FIG. 6) is formed directly on an outer surface 1282 of the battery back cover 128. The antenna structure 14 is farther away from the main board module 16, so the portable electronic apparatus 5 also can reduce the influence of the leaked electromagnetic wave by the touch panel 1642, the LCD panel 166, and other electronic components during operation effectively on the antenna structure 14. It is added that during the use of the portable electronic apparatus 5, a user often hold the battery back cover 128 with hand, so the portable electronic apparatus 5 can further include a protection film coated on the battery back cover 128 for the protection of the antenna structure 14. The above antenna structure 15 is also applicable to the configuration in FIG. 6; it is not repeated herein. Furthermore, in the embodiment, for the formation and disposition of the antenna structures 14 and 15, please refer to the description of the antenna structures 14 and 15 in the above embodiments; it is not repeated herein.

As discussed in the above embodiments, the antenna structure of the portable electronic apparatus of the invention is disposed on the most outer casing. The antenna structure is disposed as far away electronic components as possible. Though the electronic components still may leak electromagnetic wave toward the antenna structure, the portable electronic apparatus still can reduce the influence of the leaked electromagnetic wave on the operation of the antenna structure, which solves the problem that an antenna structure of a conventional portable electronic apparatus is easily interrupted in the range of the leaked electromagnetic wave in the prior art. In addition, it is added that the above embodiments are based on the fact that the decoration casing 126 and the battery back cover 128 are taken as the appearance casings, but the invention is not limited thereto. In practice, the side portion of the upper cover 122 and the lower cover 124 of the apparatus casing 12 also is relatively far away from the electronic component to be an example of the appearance casing, so the antenna structure can be disposed on the side portion. Furthermore, if the portable electronic apparatus has no decoration casing, the upper cover therefore is regarded as the appearance casing; it is not described herein. In addition, the above embodiments are based on the planar antenna structures, but the invention is not limited thereto. For example, it is practicable to dispose a three-dimensional antenna structure on one appearance casing or simultaneously on several appearance casings.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A portable electronic apparatus with antenna structure, the portable electronic apparatus comprising:
an apparatus casing having an accommodating space and an appearance casing;
an antenna structure disposed adjacent to the appearance casing; and
an electronic component disposed in the accommodating space and leaking electromagnetic wave substantially toward the antenna structure.

2. The portable electronic apparatus of claim 1, wherein the electronic component comprises an insulation protection cover disposed in the accommodating space adjacent to the appearance casing, and the antenna structure is disposed between the appearance casing and the insulation protection cover.

3. The portable electronic apparatus of claim 2, wherein the antenna structure comprises a substrate and a radiating element formed on the substrate.

4. The portable electronic apparatus of claim 2, wherein the antenna structure is embedded into or formed on the appearance casing or the insulation protection cover.

5. The portable electronic apparatus of claim 2, wherein the electronic component comprises a touch panel, and the insulation protection cover is a glass cover disposed above the touch panel.

6. The portable electronic apparatus of claim 5, wherein the antenna structure is disposed around the touch panel.

7. The portable electronic apparatus of claim 1, wherein the antenna structure is disposed on an outer surface of the appearance casing.

8. The portable electronic apparatus of claim 1, wherein the appearance casing is a decoration casing.

9. A portable electronic apparatus with antenna structure, the portable electronic apparatus comprising:
an apparatus casing having an appearance casing; and
an antenna structure disposed on an outer surface of the appearance casing.

10. The portable electronic apparatus of claim 9, wherein the antenna structure is embedded into or formed on the appearance casing.

11. The portable electronic apparatus of claim 9, wherein the antenna structure comprises a substrate and a radiating element formed on the substrate.

12. The portable electronic apparatus of claim 9, wherein the appearance casing is a battery back cover.
